(19) United States
(12) Patent Application Publication
(10) Pub. No.: US 2019/0202747 A1
(43) Pub. Date: Jul. 4, 2019

(54) INORGANIC MEMBRANE FILTER AND METHODS THEREOF

(71) Applicant: Corning Incorporated, Corning, NY (US)

(72) Inventors: Kenneth Joseph Drury, Big Flats, NY (US); Curtis Robert Fekety, Corning, NY (US); Yunfeng Gu, Painted Post, NY (US); Paul Oakleu Johnson, Corning, NY (US); Yanxia Ann Lu, Painted Post, NY (US); Zhen Song, Painted Post, NY (US)

(21) Appl. No.: 16/295,793

(22) Filed: Mar. 7, 2019

Related U.S. Application Data
(63) Continuation of application No. 14/879,377, filed on Oct. 9, 2015.
(60) Provisional application No. 62/073,486, filed on Oct. 31, 2014.

(51) Int. Cl. C04B 38/00; B01D 46/24; B01D 63/06; B01D 69/12; B01D 67/00

(52) U.S. Cl. CPC C04B 38/0009; B01D 46/247; B01D 63/066; C04B 2111/00413; B01D 69/125; C04B 38/0006; B01D 67/0041; B01D 69/12

(57) ABSTRACT

A method of making a ceramic honeycomb article which includes: applying at least one green membrane coating layer on a green substrate, the green substrate comprising a plurality of cells comprised of a plurality of interior channels and a plurality of porous interior walls between the channels; drying the at least one green membrane coating layer on the green substrate to produce a green coated substrate; and firing the green coated substrate into a porous substrate, wherein applying the at least one green membrane coating layer and the drying the at least one green membrane coating layer are repeated from 2 to 10 times prior to firing to form multiple green membrane coating layers on the green substrate and wherein the firing the green coated substrate forms a ceramic honeycomb article comprised of the porous substrate and multiple fired coating layers on the porous substrate.

This is a continuation application of U.S. application Ser. No. 14/879,377 filed on Oct. 9, 2015 which claims the benefit of priority under 35 U.S.C. § 119 of U.S. Provisional Application Ser. No. 62/073,486 filed on Oct. 31, 2014 the contents of each are relied upon and incorporated herein by reference in their entireties.

The entire disclosure of each publication or patent document mentioned herein is incorporated by reference.

### BACKGROUND

The disclosure relates to a membrane filter article and to a method of making the membrane filter article.

### SUMMARY

In embodiments, the disclosure provides a membrane filter article comprised of a porous inorganic membrane on a porous ceramic support.

In embodiments, the disclosure provides a method of making the membrane filter article comprised of a porous inorganic membrane on a porous ceramic support by, for example, applying one or more green particle coats on a green substrate, and firing the coated substrate.

In embodiments, the membrane layer on the substrate can be formed by, for example, a green-on-green coating method.

In embodiments, the membrane layer on the substrate can have, for example, one layer, two layers, or a plurality of membrane layers (multiple layers), with each layer having the same pore structure, preferably a different pore structure, and more preferably a different pore structure where each additional or successive membrane layer has a smaller pore structure than the previous membrane layer.

### BRIEF DESCRIPTION OF THE DRAWINGS

In embodiments of the disclosure:

FIG. 1 is a flow diagram showing aspects of the disclosed green-on-green coating method.

FIG. 2 shows an example of the pore size distribution of each portion of a membrane filter article.

FIGS. 3A and 3B show SEM images of an example membrane structure.

FIG. 4 shows in cross-section an example fluid flow diagram and the principle of operation in a membrane filter.

FIG. 5 shows a graph of the resulting fired cordierite membrane porosity properties as a function of graphite pore former concentration for coarse alumina or fine alumina containing cordierite starting materials.

FIG. 6 shows a graph of the resulting fired cordierite membrane pore size properties as a function of graphite pore former concentration for coarse alumina or fine alumina containing cordierite starting materials.

FIGS. 7A to 7C show exemplary SEM images of a cordierite membrane coated on inbound walls of the particulate filter.

FIG. 8 shows comparative particle filtration efficiency (FE) curves for a bare advanced cordierite (AC) filter and a disclosed membrane coated AC filter.

FIG. 9 shows a pressure drop curve comparison as a function of soot loading between a bare AC filter and a disclosed membrane coated AC filter.

FIG. 10 is a schematic and detailed view of a membrane filter structure in a cross sectional end view.

FIG. 11 is a schematic of an alternative membrane filter structure having a cross-flow configuration of the prior art.

FIG. 12 is a bar chart that shows ring-on-ring fracture strength test results of honeycomb disc samples of a disclosed Si₃N₄—SiC membrane filter (1200) compared to a pure SiC filter sample (1210).

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

### DEFINITIONS

“Fluid” or like terms refer, for example, to a liquid or a gas as a major phase and that can include one or more minor phases where at least one of the minor phases can be retained by the membrane filter article.

“Membrane” or like terms refer, for example, a porous film or layer that can be used for material separations. the disclosed inorganic membranes are made of inorganic particles that are partially sintered to form the porous structure. Membranes can be classified according to the pore size, for example, as microfiltration (MF, mean pore size of about 0.1 and 5 microns), ultra-filtration (UF, mean pore size of about 2 and 150 nm) and nano-filtration (NF, mean pore size of about 0.5 and 2 nm) membranes. Smaller pore size properties of the desired membrane call for selecting smaller or finer particles when making the membrane.

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, refers to variation in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

“Optional” or “optionally” means that the subsequently described event or circumstance can or cannot occur, and that the description includes instances where the event or circumstance occurs and instances where it does not.

The indefinite article “a” or “an” and its corresponding definite article “the” as used herein means at least one, or one or more, unless specified otherwise.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The composition and methods of the disclosure can include any value or any combination of the values, specific values, more specific values, and preferred values described herein, including explicit or implicit intermediate values and ranges.

Inorganic membranes have advantages over the organic membrane such as high chemical and thermal stabilities, which stabilities allow the inorganic membranes to be used in extreme pH and other harsh chemical environments, and in high temperature processes. The inorganic membranes can be easily cleaned or recovered for reuse. Inorganic membranes can be used, for example: in water filtration to remove particles, oils, and large molecules; in air filtration to remove particles; and in gas separation.

To achieve high permeance (the degree to which a material admits a flow of matter), inorganic membranes usually have an asymmetric structure, in which thin membranes having small pores are coated on supports having larger pores. Slurry based coating is usually used. Membranes having smaller pores can be formed by smaller particles. When smaller particles are coated on a substrate having larger pores, the smaller particles can infiltrate into the larger pores of the substrate. This infiltration of smaller particles can reduce the permeation flow rate of the membrane.

Two methods have been used to solve the infiltration problem: 1) using multiple layers of membrane having progressively deceased pore sizes (see for example, A. J. Burggraaf, et al., Fundamentals of inorganic membrane science and technology, Elsevier, 1996, page 27 -30 ); and 2) using pore blocking to prevent infiltration of small particles (see U.S. Pat. No. 7,767,256). In these processes, several firing cycles are called for, including firing the substrate and a firing for each additional membrane layer.

U.S. Pat. No. 6,699,429, assigned to Corning, Inc., mentions a process for forming a silicon nitride-bonded silicon carbide honeycomb monolith by a) forming a plasticizable mixture which includes 1) about 60% to 85% by weight, powdered silicon carbide with a median particle size of about 10-40 micrometers; 2) about 15% to 40% by weight, powdered silicon metal with a median particle size of about 5-20 micrometers; and 3) organic components; b) extruding the plasticizable mixture to form a green honeycomb monolith; c) drying the green honeycomb monolith; d) heating the honeycomb monolith to 1450° C. with a hold of 1 hr in argon; and e) nitriding the honeycomb monolith between 1450 to 1600° C. for a time sufficient to obtain a silicon nitride-bonded silicon carbide body.

U.S. Pat. No. 8,475,557, assigned to Corning, Inc., mentions using a green-on-green method for membrane coating. In green-on-green processing, membrane materials were coated on a green substrate by slurry based methods then fired to produce a membrane filter.

Since green substrates have very small pores generated by removing water during drying, small membrane coating particles cannot infiltrate into the substrates. A green-on-green coating also reduces the number of firing cycles, by at least one or more firing cycle, and therefore reduces the manufacturing cost.

In embodiments, the disclosure provides a membrane filter article comprising:
a fired porous substrate having a plurality of cells comprised of a plurality of interior channels and a plurality of porous interior walls between the channels; and
a fired porous first layer on the porous interior walls of the substrate, wherein the porous first layer has a pore size property smaller than pore size property of the walls of the porous substrate.

In embodiments, the disclosure provides a membrane filter article comprising:
a porous substrate having a plurality of cells comprised of a plurality of interior channels and a plurality of porous interior walls between the channels; and
a porous first membrane layer on at least a portion of the porous interior walls of the substrate,

wherein the porous substrate is selected from a cordierite, a silicon carbide, or a combination thereof, the porous first membrane layer is selected from cordierite, Si₃N₄ bonded silicon carbide, silicon carbide, or a combination thereof, and the porous first membrane layer has a pore size property smaller than pore size property of the interior walls of the porous substrate.

The membrane filter article can have, for example, one or more green surface coating layers applied to the green substrate. In embodiments, each successive green coating layer, if more than one layer, can have a progressively decreased pore size property compared to any of the preceding layers or compared to the green substrate. In embodiments, each successive green coating layer, if more than one layer, can have a fired pore size property that is the same or similar to any of the preceding layers or the fired substrate. In embodiments, the porous fired first layer can be, for example, a fired single coating of the coating composition, and preferably the resulting fired membrane pore size is smaller than the fired substrate or the pore size of any fired intermediate membrane layers. In embodiments, the porous fired first layer can be, for example, the result of one or more green coatings of the same composition such as from two to twenty coating layers followed by a single firing. In embodiments, the porous fired first layer on the fired substrate can have, for example, a fired porous second layer coat on top of the fired first layer. In embodiments, the fired porous second layer can be, for example, one or more coatings of the same composition such as from two to twenty coating layers.

In embodiments, the fired porous substrate, depending upon its composition and method of making, can have a mean pore size of, for example, from 3 to 30 microns such as 3 to 15 microns, a % porosity from 30% to 70% such as 40% to 60%, a cell diameter of from 1 to 4 mm, a side dimension or an edge dimension such as from 1.2 to 3.5 mm, and from 1.5 to 3.3 mm, and a wall thickness of from 0.1 to 1 mm, for example, from 0.1 to 0.8 mm, 0.2 to 0.8 mm, and 15 to 35 mil or 0.015 to 0.035 inches or 0.381 to 0.889 mm, including intermediate values and ranges; and
the fired porous first membrane layer has a mean pore size selected from at least one of: from 0.5 to 5 microns, or from 0.005 to 0.5 microns; and the mean pore size of the fired porous first membrane layer is less than the mean pore size of the porous substrate.

In embodiments, one can apply a green first layer membrane coat to the green substrate to provide after a single firing, a fired membrane having a first layer membrane thickness, for example, of from 0.5 to 5 microns. In embodiments, one can apply a second green layer membrane coat on the green or unfired first layer membrane coat to provide a membrane filter article having a fired second membrane coat having a thickness, for example, of from 0.005 to 0.5 microns.

In embodiments, the membrane filter article can further comprise a porous second membrane layer on the porous first layer, wherein the porous second layer has a pore size property smaller than pore size property of the porous first layer and the pore size property of pores of the walls of the porous substrate.

In embodiments, the porous second membrane layer can be comprised of, for example, Si₃N₄ bonded SiC, having a mean pore size of from 0.005 to 0.5 micron, and a D50 pore size that is less than the D50 pore size of the porous substrate and the D50 pore size of the porous first membrane. The SiC can be, for example, an alpha phase, a beta phase, or a combination thereof. The Si₃N₄ content can be, for example, from 1 to 30 wt % based on the total weight of the article.

In embodiments, the porous substrate in the fired membrane article can comprise, for example, Si₃N₄ bonded SiC; and the porous first membrane layer can comprise, for example, Si₃N₄ bonded SiC.

In embodiments, the porous substrate in the fired membrane article can have a porosity of, for example, from 30 to 70%; and the plurality of cells of the substrate can comprise, for example, a cell density or the cells per square inch of from 20 to 1500 cpsi.

In embodiments, the shape of the cell or the channel opening can be, for example, at least one of: a circle, a square, a rectangle, a hexagon, or a combination thereof.

In embodiments, the filter article can be, for example, an “asymmetric”, which term and like terms used herein refer to a membrane layer structure having progressively decreased pore size property in successively applied surface layers compared to the substrate pore size property.

In embodiments, the shape of the cell, that is, the channel opening can be, for example, a circular cell or a cylindrical channel having a diameter of from 1 to 4 mm, a wall thickness is about 0.1 to 1.0 mm, and a cell density is from 40 to 200 cpsi such as from 40 to 130 cpsi.

The present disclosure is advantaged is several aspects, including for example:
a membrane filter article having a reduced number (i.e., fewer) of membrane coating layers compared to prior art filters having comparable filtration properties; and
the pressure drop as shown by pressure drop curves for the disclosed filters are less severe compared to prior art filters.

In embodiments, the disclosure provides a method of making the aforementioned membrane filter article, comprising:
at least one coating of a green, i.e., unfired, substrate with at least one layer of a first green membrane source, and drying to produce a first green coated porous substrate; and
a single firing of the first green coated porous substrate to produce the fired membrane filter article.

In embodiments, the single firing of the first coated porous substrate can be accomplished, for example, at from 1400 to 1450° C., for example, when the article is a cordierite DPF.

In embodiments, the single firing of the first green coated porous substrate can be accomplished, for example, at from 1400 to 1700° C., for example, when the article has a SiC—Si₃N₄ substrate and at least one SiC—Si₃N₄ coating.

In embodiments, the single firing of the first coated porous SiC substrate can comprise at least one of:
heating the green coated green substrate in an argon atmosphere to the melting point of silicon of about 1414 to 1450° C., and preferably 1420° C., and holding at 1420° C. for 2 to 6 hrs to melt the silicon and bond it to the SiC particles of the substrate;
changing the argon atmosphere to a nitrogen atmosphere near the end of the holding period, e.g., the last half hour, to allow the nitridation to occur; and
continue heating the coated porous SiC substrate to 1500 to 1700° C., and preferably 1500° C., for from 0.5 to 10 hrs, to complete the nitridation reaction and complete the strengthening. The nitridation reaction occurs immediately when the N₂ atmosphere is present.

The nitridation reaction typically can take at least a half hour to nitridate the surface of the melted silicon powder. The nitridation continues as temperature increases, and goes to deeper nitridation until all the available melted silicon powder converts to Si₃N₄. In embodiments, the firing can include two chemical dependent temperature intervals: 1) a first nitridation firing, at from 1414 to1450° C., and preferably 1414-1425° C. The nitridation includes melting the Si powder in an Ar atmosphere, and then switching from the Ar gas to N2 gas so that the Si can react with the N₂ gas to form the Si₃N₄ material, which bonds between the SiC particles; and 2) a second strengthening firing, at from 1400 to 1700° C., and preferably 1450-1550° C. This strengthening firing allows the Si and N₂ nitridation reaction to complete and to form stronger bonding with SiC particles. In any event, the two step or two stage firing mentioned above can be completed within a single firing schedule.

In embodiments, the at least one green coating of the green substrate can comprise, for example, a slurry formulation of a Si₃N₄—SiC precursor having a solid loading of from 5 to 45 wt % comprised of: SiC particles, optionally Si particles, a binder, and a liquid carrier. When the SiC particles in the membrane coating are larger than about 1 micron, silicon particles are needed as an inorganic binder to co-coat the SiC. The Si particles can react with N₂ to form Si₃N₄ and bond to the SiC. When the SiC particles are smaller than 1 micron, the SiO₂ on the exterior of the SiC particles can react with N₂ in the presence of carbon to form Si₃N₄ that bonds to SiC. These reactions form Si₃N₄ bonded SiC in membranes. Based on these reactions, green membrane coating slurries including silicon are typically used when the SiC particles are greater than about 1 micron in diameter, and without silicon when the SiC particles are less than about 1 micron in diameter. The silicon, if selected, can be, for example, from 5 to 20 wt % based on the weight of the SiC.

The at least one coating with a source slurry, for example, an outer layer, can be SiC having a D50 of 0.6 micron in isopropyl alcohol (IPA) and having a solids loading of about 30%, and 5 wt % PVP binder.

In embodiments, the at least one green coating of the substrate can comprise, for example, a cordierite precursor or cordierite source slurry formulation having a solid loading of from 5 to 45 wt % comprised of: cordierite source materials, a binder, and a liquid carrier. The liquid carrier, such as alcohol, preferably does not substantially dissolve the green substrate constituents. The binder can be present, for example, in from 3 to 10 wt % based on the total solids content of the coating. Binders can be, for example, selected from PVP, PVB, PEI, and like binders, or combinations thereof, that are soluble in the liquid carrier. In embodiments, a pore former, such as graphite, can optionally be selected and used, for example, in an amount of from 0.1 to 60 wt % based on the weight of the solids content of the coating formulation, for the purpose of adjusting the pore structure of the fired membrane or the fired substrate.

In embodiments, the method of making can further comprise a pore former in at least one coating formulation in from 2 to 60 wt % based on the weight of the coating. In embodiments, the coating formulations, such as a particulate slurry suspended in a solvent, do not dissolve materials in the green substrate. The slurries can have a solid loading of, for example, from 5 to 50 wt % depending, for example, on the particle size of the solids. In embodiments, the composition of the coating slurry can be, for example, SiC, powdered silicon particles, a binder, and a liquid carrier. In embodiments, the composition of the green coating slurry can be cordierite precursor materials including, for example, Al₂O₃, talc, clay, SiO₂, an organic binder, a pore former, and a liquid carrier.

In embodiments, the green substrate can be prepared, for example, by extrusion, wrapping, 3D printing, and like methods, or combinations thereof.

In embodiments, the method of making can further comprise finishing at least one aspect or facet of the green coated and unfired article or the fired article, selected from at least one of:
end face machining, skinning, masking, polymer coating, sealing, ceramic glazing, membrane coating, polishing, or a combination thereof.

In embodiments, the disclosure provides a method of using the membrane filter article, comprising:
causing relative motion between a filtration apparatus having the disclosed membrane filter article installed therein and a fluid selected for filtration and separating at least one phase from another phase of the fluid. The fluid selected for filtration can comprise, for example, a first phase comprised of a gas or a liquid and a second phase comprised of, for example, particles immiscible in the first phase such as oil and water mixtures, or sand and oil mixtures.

In embodiments, the membrane filter article can be, for example, a microfilter (MF), an ultrafilter, a nanofilter, and like filter articles and like filter functions, or a combination thereof.

In embodiments, the resulting membrane filter article of the method of making can be selected, for example, as a starting substrate for making another membrane filter article having even finer pore size properties, for example, by coating the resulting membrane filter article with additional membrane coats.

In embodiments, the disclosure provides a honeycomb monolith as a substrate and having or containing a filtration membrane on at least a portion of the internal surfaces of the honeycomb monolith. In embodiments, a membrane filter article can have dimensions, for example, of about one inch in diameter and twelve inches in length, and like dimensions and permutations. A large variety of alternative substrate geometries and sizes are available or accessible. In embodiments, a membrane filter article can have a physical form of, for example, a conduit, a permeate collection channel, and like forms. Suitable materials for construction of the honeycomb and the membrane, can include sources of, for example, silicon carbide (SiC) materials, alumina, cordierite, and like source materials, or combinations thereof. The method of making the filter article can produce a membrane filter article comprising, for example, at least one Si3N4 membrane layer bonded to SiC particles of the substrate. In embodiments, the D50 pore size of the porous membrane layer can be, for example, 0.1 micron to 1 micron.

In use, the membrane filter article can be placed in a suitable housing and contacted with a fluid (e.g., a gas, a liquid, suspension, etc.) for separation or remediation. The membrane filter article can have a liquid flux of, for example, pure water of 1,000 to 5,000 L/h/m²/bar such as 2,000 L/h/m²/bar or more.

In embodiments, the membrane filter article can have a filtration efficiency with skim milk, for example, of greater than 80%. Other attributes of the disclosed membrane filter article can include, for example, chemical durability, abrasion resistance, for example, to sand or like abrasives, and flux sustainability.

In embodiments, the disclosure provides a method for making a membrane filter article, comprising: green coating, for example, a source of a cordierite membrane on a green substrate such as a source of cordierite.

In embodiments, the disclosure provides a method of making an inorganic membrane filter article comprised of Si₃N₄-bonded SiC membrane on a Si₃N₄-bonded SiC substrate.

In embodiments, the disclosed method selects the green membrane coating materials so that a SiC particle bonding material, for example, Si₃N₄ or like compound, can be formed at the same time and firing temperature for both substrate and membrane(s), which concurrent formation allows the substrate and the membrane to be fired at the same time.

In embodiments, the disclosure provides a raw material or starting material for forming a fine pore cordierite. This starting material contains very small size alumina particles, which particles can form fine pores and also provide high porosity. For example, when using Al₂O₃ having a particle size of 0.7 microns, and other starting materials such as SiO₂, talc, and clay, having a particle size of from 3 to 7 microns, the resulting fired cordierite membrane can have a pore size of about 3 microns and porosity of about 60%. This cordierite source starting material has a cordierite formation temperature of from about 1400 to about 1450° C. Firing the green membrane(s) and the green substrate at the same time reduces the number of firing cycles, and reduces the cost of membrane products. Firing is a significant cost in making a ceramic membrane.

In embodiments, the disclosure provides a method of using the inorganic membrane filter article to filter a fluid, such as a liquid or a gas, and where the fluid can have two or more phases present, such as solid particle phase or a liquid particle phase suspended in a liquid phase or a gas phase.

The front open area (FOA) of the substrate can be, for example, from 30% to 70%, and a preferred FOA can be, for example, from 35% to 60%. The FOA can be used to define the substrate including wall thickness. If the FOA is too low then it means the wall is too thick and the substrate has a lower membrane surface area and a lower flux. If the FOA is too high then it means the wall is too thin and the substrate is not good for liquid permeation flux. The disclosed SiC membrane filter articles can have a channel dimension, for example, of from 1.5 to 3.5 mm, and have an FOA of about 52%.

Green substrates can have much smaller pores compared to fired substrates (because the space between particles can be occupied by, for example, a polymeric pore former or binder, so that coating on a green substrate does not have the aforementioned infiltration problems. The absence of the infiltration issue permits the use of green membrane coating formulations have smaller particle sizes and can potentially reduce the number of coating steps.

Compared to conventional cordierite membrane coatings, cordierite particles of the proper size have to be formed de novo or large cordierite particles have to be ground to the proper smaller size to be used for membrane coating. In green-on-green coating, one can choose different starting material having desired particle sizes and use them directly for green membrane coating.

Referring to the Figures, FIG. 1 shows a flow chart of green-on-green membrane fabrication process (100), where a green substrate (105) can be dried (110), and then coated with a membrane coating (125) to provide a green membrane coated green substrate. The green membrane coating (125) and drying steps can be repeated to form multiple layers of the green membrane coating having the same or different pore structures (125) on the green substrate prior to a single firing (115). The single firing (115) results in an asymmetric membrane (120) structure. A first layer of a membrane can be coated directly on a green substrate filter and then dried. A second layer of the membrane can be coated on the first coat, and then dried as for the first coat. This green coating and drying sequence can be repeated multiple times, such as from 1 to 10 or more cycles, so that the green membrane achieves the correct layer thickness(es), and proper pore structure(s). For example, a coarser first membrane can be achieved by a first coating as an first intermediate layer to smooth the substrate surface roughness. A finer thin second green membrane coating can be coated over the first or intermediate green membrane layer. The resulting first and second green membrane coated substrate can be fired a single time to form a final asymmetric structure membrane filter article. Since the green substrate has very fine pores, there is little or no particle infiltration from the coating. A coating composition can be coated directly on the green substrate, which coating composition can provide a targeted pore structure after firing.

The membrane coating can be accomplished by any suitable method, for example, slip casting, waterfall coating, dip coating, vacuum coating, and like methods, or combinations thereof.

The coating slurry can be formulated with a solvent that is, for example, compatible with the green substrate. A green substrate may contain a water soluble binder or a pore former. For such green substrates, the coating slurry is preferably other than water based. Instead, an alcohol or the like solvent, based slurry can be selected.

The green coating materials can be, for example, a single inorganic component, or multiple inorganic components, depending on the form of the final ceramic membrane.

In a single inorganic component slurry, the slurry can contain, for example, a solvent, an organic binder, and inorganic particles of a particular size property.

In a multiple inorganic component slurry, the slurry can contain, for example, a solvent, an organic binder, an optional or alternative inorganic binder, and inorganic particles of particular size property.

The above slurries were used to form green membranes on an original green inorganic matrix. These green membrane particles can be, for example, either bonded by sintering of themselves, or bonded by the inorganic binder/sintering aid between particles, or bonded by reactively formed bonding materials during firing.

Another kind of multiple component inorganic slurry contains a solvent, an organic binder, and ceramic forming precursor or starting materials. This kind of slurry coated membrane can reactively form membrane materials.

In any of the slurries, a pore former can optionally be added to increase the porosity and adjust the pore size to a certain range in the resulting fired inorganic membrane filter article.

In embodiments, green coated membrane drying is preferably accomplished in a controlled environment to prevent drying too fast to cause drying cracks (aka. mud cracking).

In embodiments, multiple layers of membranes having different pore structure can be coated on the same substrate to form asymmetric structure membrane.

In embodiments, to prevent firing cracks, the coefficient of thermal expansion (CTE) of the membrane should preferably match the CTE of the substrate in the final membrane filter article. The material selection should also consider the formation temperature match for membrane and the substrate. In embodiments, selecting the same green membrane material as used for the green substrate is preferred.

The disclosed green-on-green membrane coating process is particularly suitable for those membrane systems having the ceramics or bonding formed by the same reaction or the same reaction temperature for both substrates and membrane(s).

The disclosed membranes can be used in, for example, liquid filtration or gas particular filtration.

In embodiments, the membrane filter article can be formed, for example, having a tubular or honeycomb structure.

In the formation of a Si₃N₄-bonded SiC membrane, from 5 to 30 wt % Si can be embedded in SiC green matrix in either or both the substrate and the membrane. The firing can be carried in an inert gas, such as Ar, to a silicon melting temperature of about 1414 to1450° C., such as 1420° C. for 2 to 6 hrs. The gas can then be switched to N₂ for the nitridation reaction of Si. The nitridation temperature can be, for example, from 1414 to 1700° C., preferably from 1420 to 1500° C. The nitridation above the silicon melting point results in Si₃N₄ grains that bond to SiC particles. Otherwise, nitridation tends to form Si₃N₄ whiskers or rods that can affect the pore structure of the substrate. At this temperature, the Si₃N₄ forms by reaction of the Si and the N₂. The Si₃N₄ bonds to the SiC particles in the substrate and the membrane layer.

For small SiC particles (e.g., less than 1 micron), the surface SiO₂ surrounding the SiC particles can provide a Si source for forming Si₃N₄ bonding materials.

In embodiments, in making a Si₃N₄—SiC microfiltration (MF) membrane, a two layer membrane can be applied on the substrate. The fired substrate pore size can be, for example, from 3 to 30 microns, preferably 3 to 15 microns. The fired first or intermediate membrane layer pore size can be, for example, from 0.5 to 5 microns. The fired top layer membrane layer pore size can be, for example, from 0.005 to 1 microns, preferably 0.05 to 0.5 microns, including intermediate values and ranges. In embodiments, the membrane filter can have, for example, a two layer membrane structure. In embodiments, the membrane filter can have, for example, a single layer membrane structure.

In embodiments, the disclosed green-on-green method of making a filter article permits a single green membrane coating layer to be applied to a green substrate prior to firing.

In the formation of a cordierite membrane filter article, the disclosure provides a method to achieve both fine pores and high porosity for the filter article. A conventional method of making smaller pore size ceramics is to decrease the particle size of the raw materials. In cordierite formation, all the starting material particle sizes are usually selected to be in a relatively narrow range, e.g., all particle sizes are from 5 to 20 microns, or from 5 to 10 microns. In the disclosed method, a much smaller alumina particle size was selected, e.g., of about 0.6 microns or smaller. The other starting materials have a particle size of about 5 to 10 microns. The small particle size alumina starting material permits making a cordierite membrane having fine pores (e.g., 3 microns or smaller) and high porosity (e.g., greater than 60%). In embodiments, adding a pore former (e.g., 10 to 60 wt %) of a particular size (e.g., 2 to 8 microns), the membrane pore uniformity and porosity can be improved to a D factor (Df=(D50−D10)/D50) of 0.35.

### EXAMPLES

The following Example(s) demonstrate making, use, and analysis of the disclosed membrane filter articles in accordance with the above description and general procedures.

### Example 1

Si₃N₄-bonded SiC microfilter (MF) membrane coated by the disclosed green-on-green method. A green SiC honeycomb substrate containing 20 wt % powdered silicon was formed by extrusion and dried. The SiC particle size was 28 microns at D50, and the powdered Si particle size was 5 microns at D50. The extruded substrate contained, by super addition, 8 wt % of hydroxypropyl methylcellulose (F240 LF) binder, 3 wt % of fatty acid and tall oil as lubricant, and 10 to 30 wt % of a pore former, such as corn starch or wheat starch. Two membrane layers were coated on the green SiC honeycomb substrate by slip casting with an intermediate drying accomplished after each coating, and prior to firing the membrane coated honeycomb substrate.

The first layer or intermediate layer (e.g., when there is a subsequent top or over coating) membrane coating slurry composition was prepared by combining HSC1200 SiC (Superior Graphite) and high purity (99.9%) powdered silicon having a particle size of from 1 to 2 microns (commercially available from, for example, American Elements). The weight ratio of the SiC:powdered silicon was 100:8. These ingredients were added into isopropyl alcohol (IPA) to form a slurry having 40 wt % solids loading. PVP (Luvitec VPC 55K 65W) of 5 wt % of total solid weight was added as an organic binder. The slurry was ball milled for 24 hrs to decrease the SiC particle size to D50 of 3.3 microns. The slurry was coated on the green substrate by dip-coating. The dip-coated substrate was immediately mounted on a spinner to remove the excess slurry in the channels by centrifugation. The part was dried at room temperature for 24 hrs. A second coat of the first layer membrane coating composition as a slurry and using the preceding procedure was applied to the once coated substrate. When dried, the part was ready for a top coating layer.

Top layer coating: A second membrane coating composition was prepared by adding HSC059N silicon carbide (SiC) (b-SiC particles from Superior Graphite) (D50 of 0.6 microns) to isopropyl alcohol (IPA) to make a slurry having a 30 wt % solid loading. PVP at 5 wt % based on the weight of the SiC was added as an organic binder. The resulting slurry was ball milled for 24 hrs. The green substrate having the first intermediate layer green membrane coat was dip-coated into the milled slurry. A second coat using the second intermediate layer membrane coating composition and the preceding procedure was applied to the second intermediate green layer membrane coated substrate to complete the top green layer coating.

After drying, the resulting green substrate having a double green coat of the first and a single second green layer membrane coating was first fired at 450° C. for 2 hrs in air to remove organic materials in the substrate and in the membrane coats. The coated substrate was then transferred to an air controlled tube furnace for firing. The firing schedule and firing gas environment were:
RT to 1420° C., at 60 to 120° C/hr, in Ar;
at 1420° C. hold 2 to 6 hours, after 0.5-5.5 hours of holding,
change Ar to N₂;
1420° C. to 1500° C., at 60° C/hr, in N₂;
1500° C. hold for 6 hrs in N₂; and
1500° C. to RT, at 60 to 120° C/hr, in N₂.

During the firing sequence, the following phase change and reaction is believed to have occurred in the substrate and the coated membrane:

$$Si ( sol . ) {\to }^{1414 ° C . , Ar} Si ( liq . )$$

$$3 Si + 2 N 2 {\to }^{1350 to 1700 ° C . in N 2} Si 3 N 4$$

Since the Si melting and Si—N₂ reaction are the same in both substrate and membrane, this system is suited for making a green membrane coating and firing the green membrane coated green substrate together.

In measuring the membrane pore size and porosity, each coating slurry was poured into a flat bottom container to dry and to form thin chips (i.e., a stand-alone membrane). The membrane chips were separately fired at the same time with green substrates. The fired substrate and chips were separately measured with Hg-porosimetry to approximate the pore structures of the membrane filter at each membrane layer and the substrate by the disclosed green-on-green coating and one time firing.

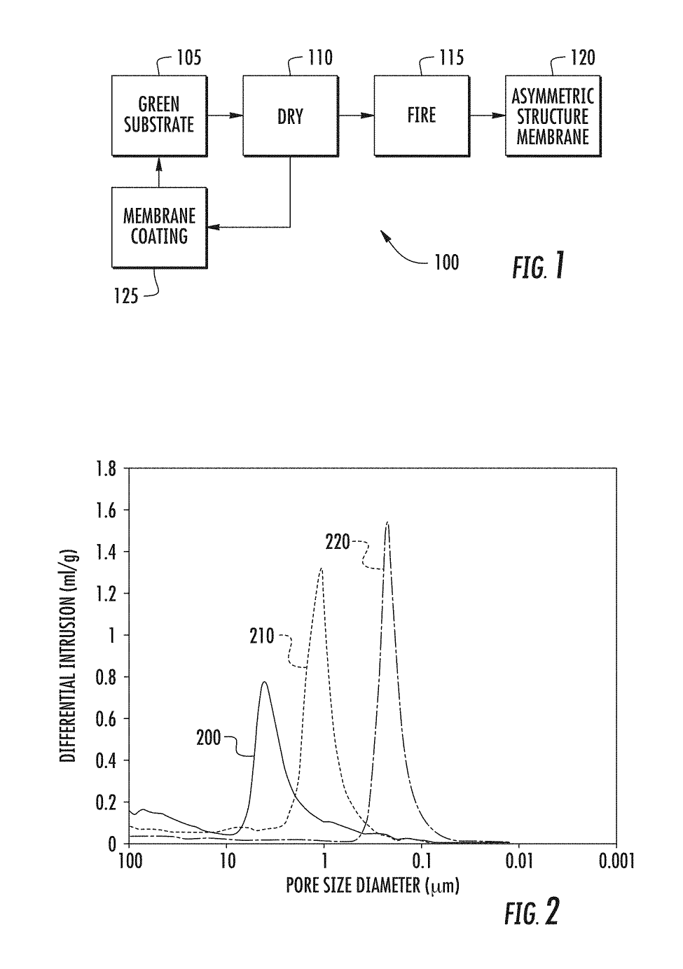

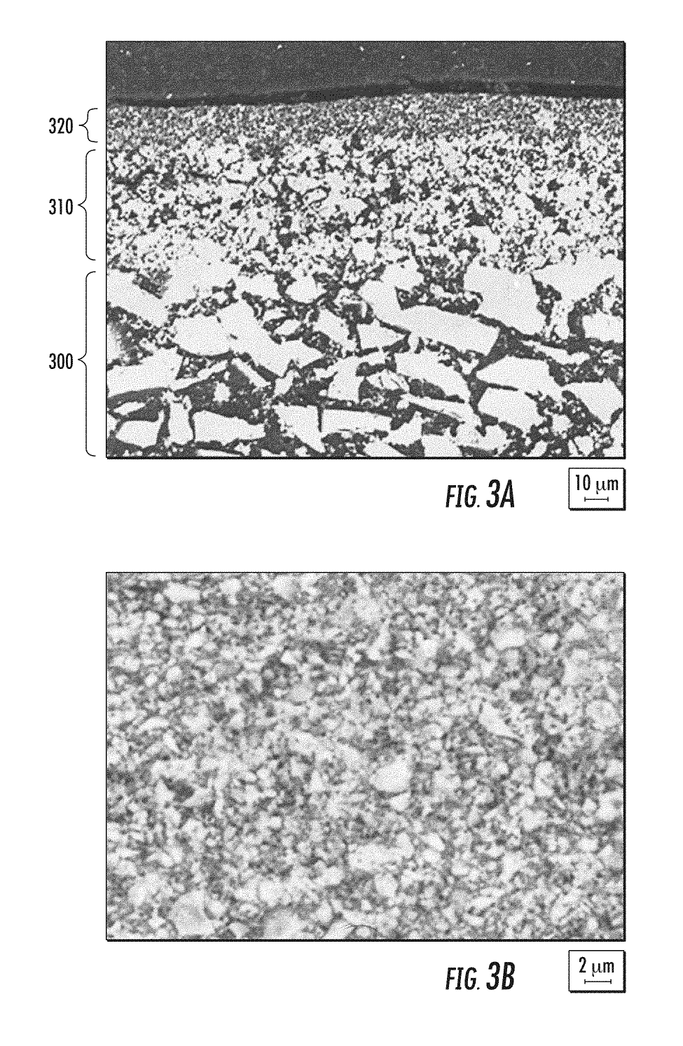

FIG. 2 shows pore size distributions as determined by the differential intrusion method of each portion of the membrane filter article coated by the process of Example 1 in the stand alone form, including the substrate (200) having a pore size of 4.2 microns, the intermediate layer (210) having a pore size of 1.1 microns, and the top layer (220) having a pore size of 226 nm. Table 1 lists the porosities as measured by Hg-porosimetry of the fired substrate and each of the fired membrane coated layers.

TABLE 1
Porosities of the each portion of the
membrane coated article of Example 1.

| | % porosity |
|---|---|
| Substrate | 61 |
| First or intermediate porous layer | 65 |
| Top or second porous layer | 59 |

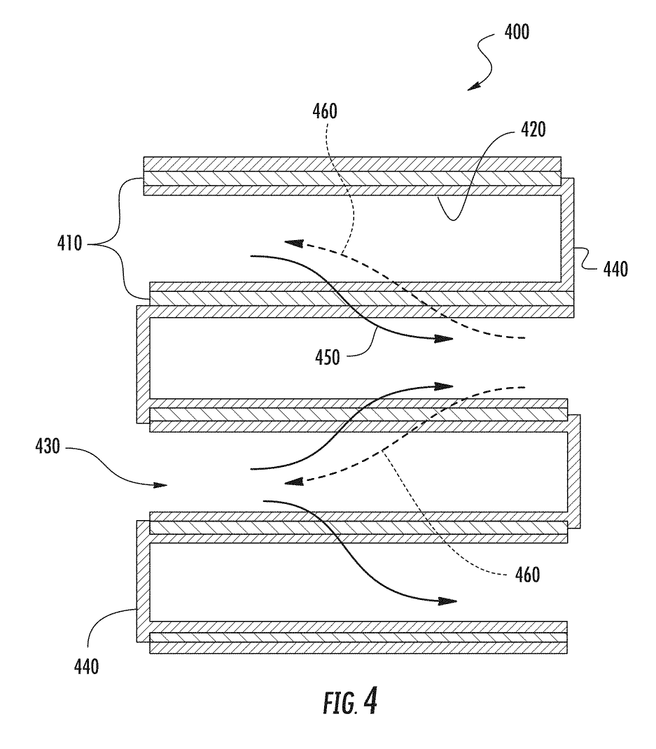

FIGS. 3A and 3B shows SEM images of an exemplary membrane filter structure of Example 1. FIGS. 3A shows a cross-section image of the substrate (300), the intermediate layer (310) and the top layer. FIGS. 3B shows the membrane filter top surface (320) SEM image.

For the top or outermost fine pore SiC layer, no Si was added. XRD analysis showed the formation of Si₃N₄ in the membrane. These Si₃N₄ can formed by reaction of N₂ with SiO₂ that formed on the surface of fine SiC particles.

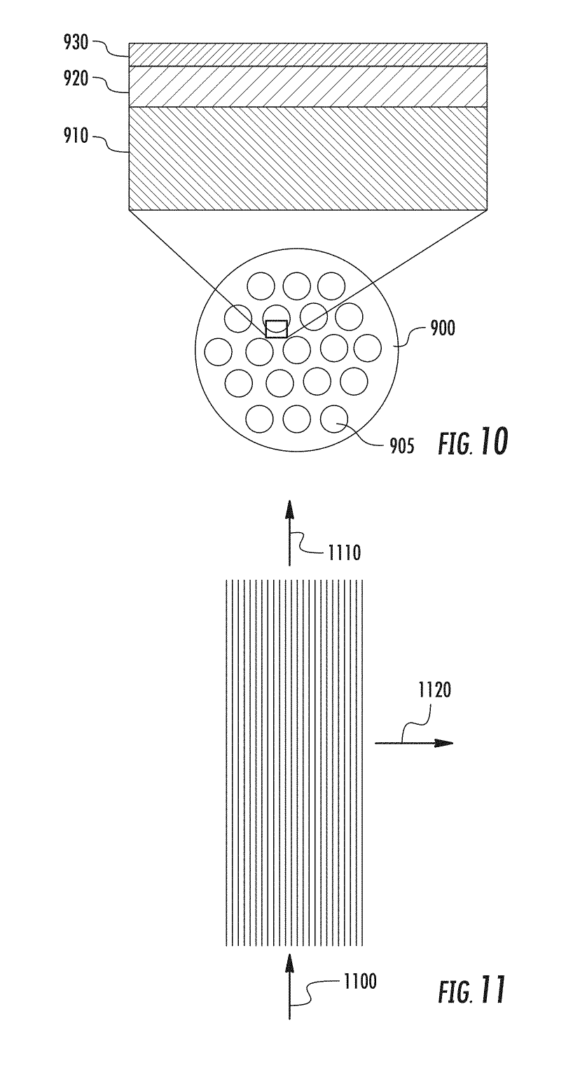

FIG. 10 is a schematic of a membrane filter structure in end view (900) having openings or apertures (905) leading to channels in the body of the filter, and wall structure having a thick substrate (910) portion, a first coat layer (920), and a second coat layer (930). The thick substrate (910) portion can have a wall thickness of, for example, from about 0.1 to 0.8 mm and a pore size of, for example, from 3 to 15 microns. The first fired membrane coat layer (920) can have a thickness of, for example, from about 1 to 60 microns, and a pore size of, for example, from 0.5 to 5 microns when used as an intermediate layer, or 30 to 100 microns in thickness and 0.05 to 0.5 microns in pore size when used as top layer. The second membrane coat layer (930) can have a thickness of, for example, from about 10 to 40 microns, and a pore size of, for example, from 0.05 to 0.5 microns. In embodiments, the membrane filter structure can have one or more egression channels. In embodiments, the membrane filter can have, for example, a two layer membrane structure. In embodiments, the membrane filter can have, for example, a single layer membrane structure. This is one advantage of the disclosed green-on-green coating method; reducing the number of coating layers and associated handling and material costs. In green coating, the intermediate layer can function to smooth the channel surface and allow a top layer coating to be as thin as possible for higher filter flux. When the smoothness of the channel surface is acceptable, a top layer can be coated directly on the substrate. In conventional membrane coating methods, the intermediate layer is often necessary. The intermediate layer can prevent infiltration of fine coating particle of the subsequently applied top layer coating. In embodiments, multiple intermediate layers can be applied to progressively decrease the pore size of the filter article.

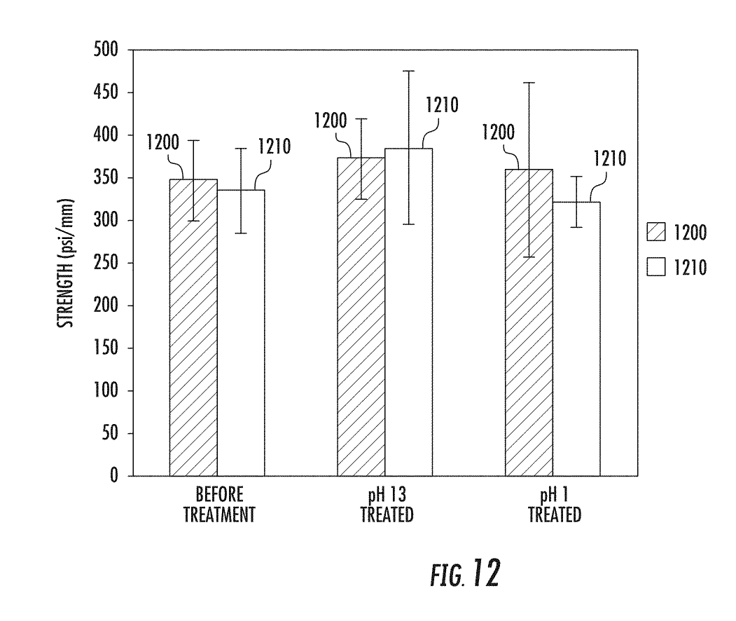

FIG. 11 is a schematic of a membrane filter structure having a cross-flow configuration of the prior art, including a feed stream (1100), a rejection stream (1110), and a filtration stream (1120).

### Membrane Chemical Durability Test

A membrane filter with the above Si₃N₄—SiC membrane structure was soaked in pH 13 aqueous NaOH solution at 60° C. for a total of 264 hrs to simulate possible membrane cleaning conditions. The membrane was measured for water flux and skim milk filtration efficiency after the indicated hours of soaking. Table 2 shows the results.

TABLE 2
Si₃N₄—SiC membrane chemical durability evaluation.

| | | Milk filtration efficiency after | | |
|---|---|---|---|---|
| Si₃N₄—SiC filter | Pure water flux | run time (minutes) | | |
| treatment | (L/min/h/bar) | 1 min | 5 min | 10 min |
| Original | 533 | 87% | 91% | 94% |
| membrane filter | | | | |
| In pH 13 NaOH | 548 | 88% | 92% | 94% |
| @60° C. for 72 hr | | | | |
| In pH 13 NaOH | 548 | 88% | 92% | 95% |
| @60° C. for 192 hr | | | | |
| In pH 13 NaOH | 559 | 91% | 95% | 96% |
| @60° C. for 264 hr | | | | |

Cylindrical honeycomb membrane filters having a 1 inch diameter were cut into 2 mm thick discs, and the ring-on-ring strength was measured before and after exposure to pH 13 (aq NaOH), 60° C. for 72 hrs treatment, and at pH 1 (aq HCl), 60° C. for 72 hrs. FIG. 12 shows the strength results of a disclosed Si₃N₄—SiC membrane filter (1200) and compared with a pure SiC filter sample (1210) (commercially available from Liqtech) before and after the same treatments. The strength and the chemical durability of the disclosed Si₃N₄—SiC membrane filter was comparable to the commercial pure SiC membrane filters.

### Example 2

Cordierite membrane coating on cordierite honeycomb for improved filtration efficiency in a diesel particulate filter (DPF) This Example demonstrates reactively forming the same ceramic material in both the substrate and the membrane coat. This Example also demonstrates a method of making a fine pore membrane by the green-on-green method.

A green substrate, which is a precursor to an advanced cordierite (AC) (Corning diesel particular filter) product, and containing cordierite precursor materials, including Al₂O₃, talc, clay, SiO₂, an organic binder, and a pore former, was selected as the substrate for the membrane coating. A layer of a fine pore membrane coated on the filter can enhance the filter's particulate filter function and other air filtration performance. The membrane was coated in alternate channels such as shown in FIG. 4, that is, on the inlet side but not the outlet side of the plugged filter.

FIG. 4 is a cross-section illustration of the membrane coating on channels of a filter member (400), such as a diesel particulate gas filter or a liquid filter, and the definition of inlet, outlet, forward flow, and reverse flow. In embodiments, the membrane coating can be, for example, on inlet side channels only. In embodiments, the gas or liquid fluid flow coming in from one side passes through the walls and out the other end in a so-called through wall filter. The membrane layer (420) is on the wall (410) of the membrane filter article (400) such as a honeycomb, and the membrane and the substrate wall can interact with the gas or liquid fluid flow through the interior walls. Fluid flowing into the membrane filter (430) penetrates the walls (410) and optionally the end seals (440) or plugs, and exits the filter as forward fluid flow (450) from the inlet side (left) to the outlet side (right) leaves the retentate material (not shown) trapped in the filter. Reverse gas or liquid fluid flow is indicated by the arrows (460).

The channels having the membrane coatings can be, for example, the inlet channels, and the channels without coatings can be, for example, the outlet channels. Fluid flow from inlet to outlet is referred to as forward flow, and fluid flow from outlet to inlet is referred to as reverse flow.

In embodiments, a procedure of the membrane fabrication based on a green-on-green membrane coating follows:
1. Plastic mask the green substrate (free of end plugs) at both of the ends with a checker board pattern so that one set of the channels is open at both ends, and the other adjacent set of the channels is blocked at both ends;
2. Coat the masked green substrate with the green slurry in IPA carrier. The coating can be conducted by, for example, the waterfall method;
3. Dry the substrate at room temperature for 24 hrs;
4. Repeat the coating and drying until the coating reached to desired loading;
5. Fire the green membrane coated green substrate;
6. Polish one or both ends of the membrane coated and fired substrate to a target length and, if desired, plug alternate channels on one end of the filter with a ceramic material checker board pattern to form dead-end structure for each channel as shown in FIG. 4.

In embodiments, the disclosure provides a method of making a fine pore cordierite membrane filter articles using a small size alumina. Of the raw materials for forming cordierite, the alumina has the highest melting temperature. It forms a backbone structure in the final cordierite. In embodiments of the disclosed method, small particle size alumina was selected to form a cordierite membrane having small pore size and high porosity cordierite membrane. Table 3 shows the starting materials for cordierite membrane formation.

TABLE 3
Starting materials for cordierite membrane formation.

| Starting materials | Wt % | D50 (microns) |
|---|---|---|
| talc | 41.57% | 6.93 |
| silica | 16.61% | 4.59 |
| clay | 13.87% | 3.32 |
| alumina (fine) | 27.95% | 0.66 |
| Comparative alumina | 27.95% | 3.0 |
| (coarse) | | |
| graphite pore former | 0% to 60% | 1.5 |

The coating slurry was prepared by adding the raw materials powders of Table 3 into IPA to make 40 wt % solid loading slurry. A 4 wt % of PVP by super additional was added to the slurry as an organic binder. The slurry was ball milled for 24 hrs, and then waterfall coated on to a green substrate with three coating-drying cycles. The coated substrate was then fired in air according to the schedule:
RT to 1000° C., at 50° C/hr
1000 to 1200° C., at 25° C/hr
1200 to 1415° C., at 50° C/hr
1400 to 1415° C., at 39° C/hr
1415° C. hold, 10 hr
1415 to 1100° C., at 50° C/hr
1100 to RT, at 300° C/hr.

After firing, the substrate had a pore size of 22 microns (D50) and 50% porosity. Without adding a pore former, the membrane had a membrane pore size of 3 microns (D50) and a porosity of 60%. By progressively adding a pore former (e.g., 1 to 2 microns graphite particles) up to 60 wt % of the solid, the membrane pore size was gradually increased to 7 microns, and the membrane porosity gradually increased to 70%.

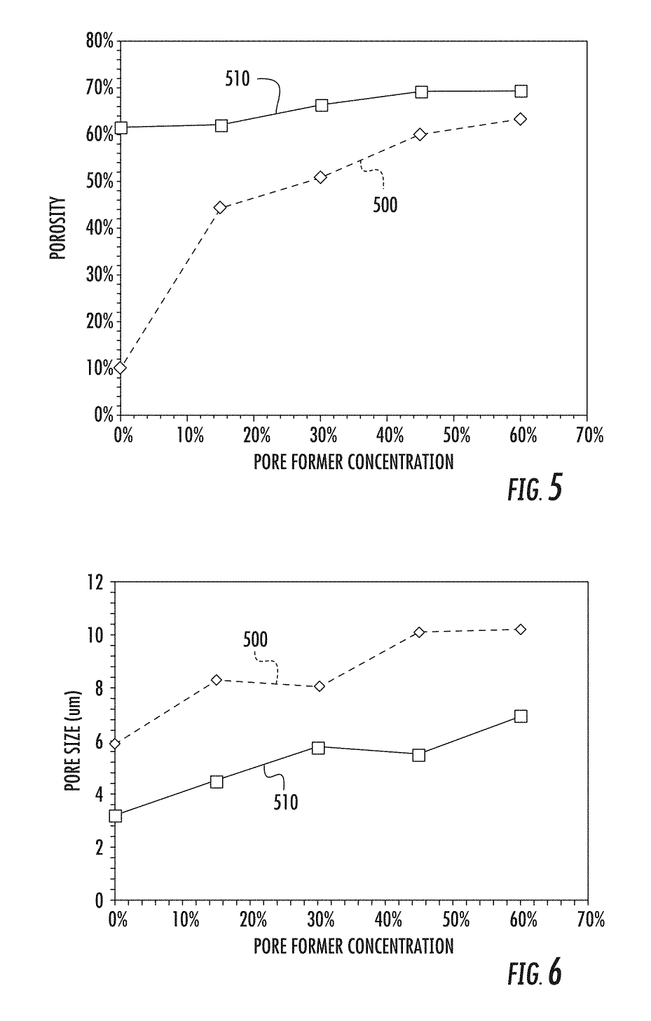

FIG. 5 shows a graph of cordierite membrane pore size properties versus graphite pore former concentration, for coarse (500) Al₂O₃ particles of the membrane starting material having a particle size of about 3 microns, and fine (510) Al₂O₃ particles of the membrane starting material having a particle size of about 0.6 microns. In a comparison experiment, a starting material containing coarse alumina having a particle size of 3 microns (D50) was used. All the other starting materials were the same as shown in Table 3.

FIG. 6 shows a graph of the cordierite membrane pore size versus the graphite pore former concentration for coarse (500) Al₂O₃ particles of the membrane starting material and fine (510) A1203 particles of the membrane starting material. With the coarse alumina, Al₂O₃, the pore size of the resulting cordierite membrane was increased to 6 to 10 microns, and the porosity was decreased to from 10 to 60% for the corresponding increased concentrations of progressive graphite pore former addition. The comparison indicates that fine Al₂O₃ in the starting materials enables formation of a membrane having a higher porosity property and a smaller pore size property. These pore properties afford higher filtration efficiency and lower back pressure. By using an even smaller particle size Al₂O₃ (fine alumina), an even smaller pore size can be achieved.

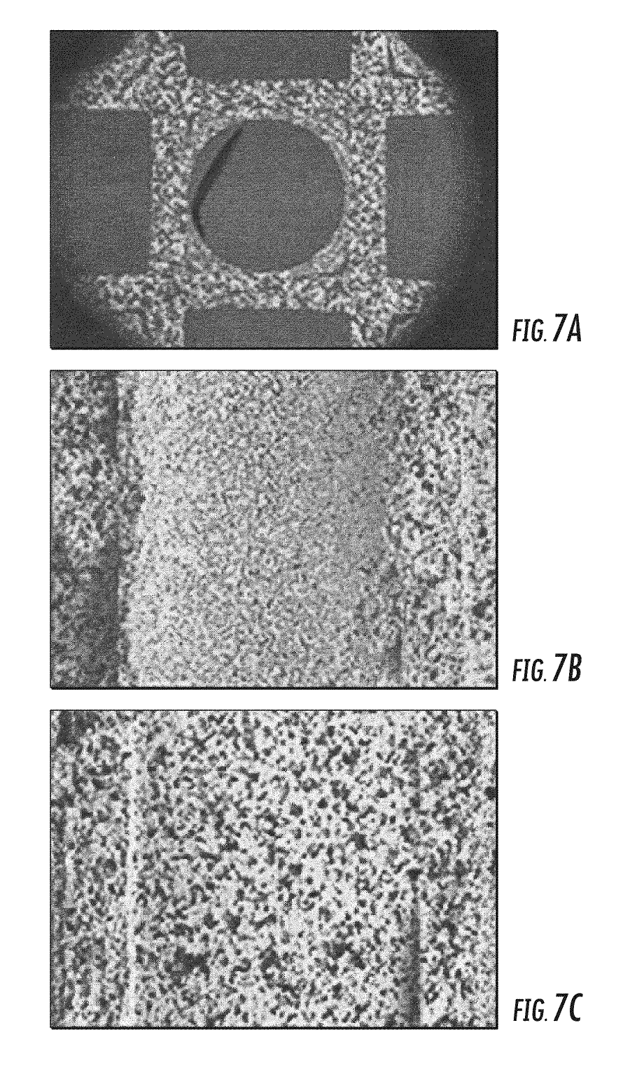

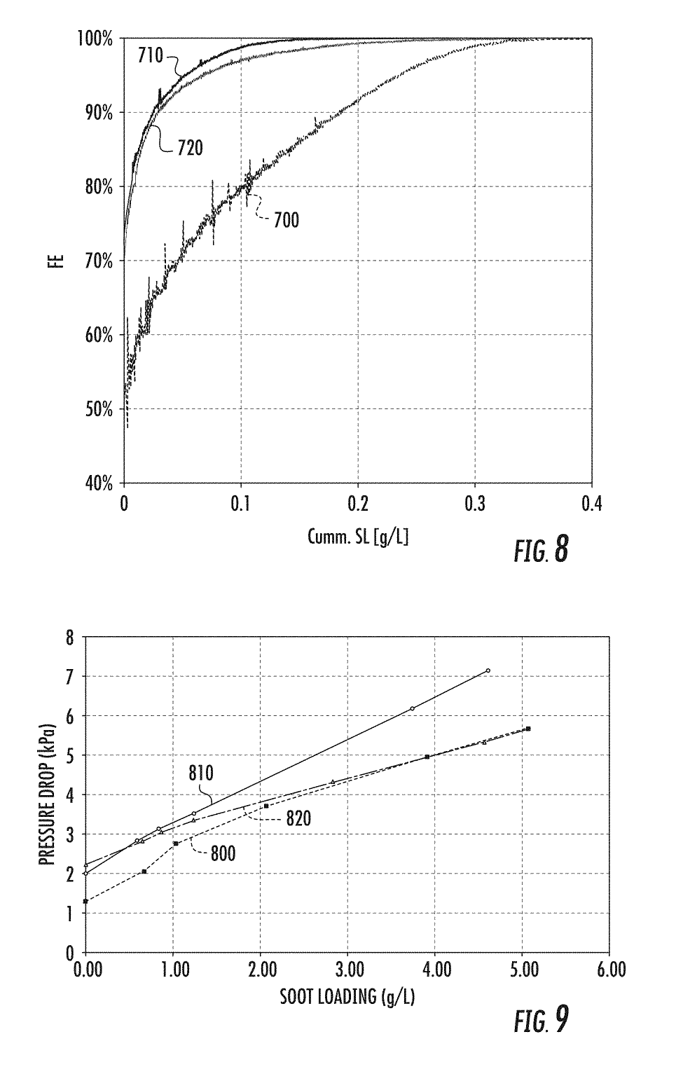

FIGS. 7A to 7C show SEM images of a cordierite membrane coated on alternating channel walls of the particulate filter having a membrane material loading of 87 g/L. The membrane was coated using a slurry containing the 0.66 micron (D50) fine alumina and 45 wt % in super addition of a graphite pore former. The thinnest part of the membrane was about 100 microns. FIG. 7A shows an SEM image of a cross-section of the filter channels. The rounded alternating channels were coated with membrane. The square channels were not coated with membrane. FIG. 7B shows an SEM image of a membrane coated channel surface. FIG. 7C shows a comparative SEM image of a non-coated channel surface.

The coated filters were measured for diesel particulate filtration efficiency (FE) and pressure drop in both forward and reverse flow directions.

FIG. 8 shows particle filtration efficiency (FE) curves comparing a bare advanced cordierite (AC) filter (700), that is, a non-membrane coated filter, and a disclosed membrane coated AC filter, and the efficiency of the two respective flow directions of the coated membrane filter; forward (710) and reverse (720), where “CUM.SL” refers to “cumulative soot loading” or the total amount of soot in grams retained by the filter for a specified filtration period. The membrane coated filter had an inorganic solid loading of 87 g/L. In this particular membrane, the 0.66 micron fine alumina was used in the alumina starting material slurry, together with 45 wt % by super additional of a graphite pore former. Compared to the non-coated filter, the coated filter's initial filtration efficiency was increased 40%, from 50% for the non-coated filter and to 70% for the membrane-coated filter. The forward flow curve (710) reached 100% filtration slightly faster than the reverse flow curve (720), indicating a faster build-up of soot cake on the membrane coated surface. However, there was almost no difference for the forward flow and reverse flow at the initial filtration point. The total leaked particles for non-coated AC filter was 2.53×10¹³, and total leaked particles for the coated filter in the forward and reverse directions were 5.23×10¹² and 6.63×10¹², respectively. The membrane coated filter showed almost an order of magnitude improvement for the soot filtration.

FIG. 9 shows the comparative pressure drop curves for the non-coated filter (bare AC filter) (800) and for the disclosed membrane coated AC filter as a function of soot loading between, for the respective filter flow directions: forward (810) and reverse (820).

Although the membrane coating caused a slight increase in the clean filter pressure drop, when used in the reverse flow direction, the soot loaded pressure drop was even smaller when the soot loading was more than 4 g/L. Another advantage of membrane coated filter is that the pressure drop curves have a much smaller knee or even no knee, i.e., bend or inflection in the curve. The knee on a pressure drop curve predicts difficulty in automatic control of the filter regeneration process.

Table 4 lists the filtration performance comparison for filter with and without membrane coating.

TABLE 4
Comparison of the DPF performance of a bare AC filter
and a S2 (i.e., a slurry) coated membrane AC filter.

| | | | | PD | PD |
|---|---|---|---|---|---|
| | Flow | Initial | Accum. | (clean) | (5 g/L soot) |
| Sample name | direction | FE | Ptcl. # | (kPa) | (kPa) |
| Bare AC | | 50.8% | 2.53E+13 | 1.28 | 5.64 |
| Membrane | Forward | 70.0% | 5.23E+12 | 2.2 | 5.59 |
| coated | | | | | |
| AC | Reverse | 70.3% | 6.63E+12 | 1.98 | 7.6 |

### Example 3

Skim milk filtration test results for membrane filters. Two parameters that are important in measuring a filter's performance are efficiency and flux. Pure water flux is measured by L/m²/hr/bar, where L is the volume in liters of water coming out from permeate stream per surface area of membrane per hour per bar of back pressure across the membrane.

Diluted skim milk(e.g., as-purchased skim milk to water volume ratio was about 1:10 to provide an NTU number in from 600 to 750, that is, a turbidity of about 700), was used as a representative fluid sample for filtration. Skim milk contains protein particles having a D50 size of about 0.2 microns.

For the measurements, the following conditions were used:
an average pressure drop over the membrane was about 25 psi;
a rejection flow rate was controlled at 8 gallons per minute (Ga/min); and
the linear velocity of the fluid through the filter channel was about 3 to 4 m/s.

In pure water flux measurement DI water was used. The flow rate in the permeate stream was measured to calculate the pure water flux. The filtration efficiency was determined by measuring changes in turbidity. Solution turbidity (NTU number) measurement before and after the filtration was used to calculate the filtration efficiency. The starting milk turbidity was about 700 NTU. Liquid from the permeate stream coming out at 1 min, 5 min, and 10 min, after starting the filtration was collected, and the NTU was measured. The fraction of the turbidity (NTU) being removed was the filtration efficiency. Table 5 provides selected skim milk filtration test results for disclosed membrane filters having a Si₃N₄-bonded SiC (1″×12″) membrane, having a double- or 2-layer membrane (A), or a single- or 1-layer membrane (B), coated/supported and fired on a silicon carbide honeycomb substrate. Membrane (A) had a first or intermediate membrane layer fired thickness of about 1 micron and a second or top membrane layer fired thickness of about 0.2 microns. Membrane (B) had a single or 1-layer fired thickness of about 0.2 microns. The results indicated that both membrane filter configurations (A & B) provided excellent flux and filtration efficiency properties. The 2-layer membrane filter configuration had superior flux and initial filtration efficiency (i.e., up to 1 min run time).

TABLE 5
Skim milk filtration efficiency test results with disclosed
Si₃N₄—SiC membrane on SiC substrate filters.

| | | Skim Milk Filtration | | |
|---|---|---|---|---|
| | Pure water flux | Efficiency | | |
| Si₃N₄—SiC Membrane Type | L/h/m²/bar | 1 min | 5 min | 10 min |
| A (2-layer) | 1876 | 84% | 95% | 97% |
| B (1-layer) | 1704 | 48% | 88% | 94% |

The disclosure has been described with reference to various specific embodiments and techniques. However, it should be understood that many variations and modifications are possible while remaining within the scope of the disclosure.

What is claimed is:

1. A method of making a ceramic honeycomb article, comprising:
applying at least one green membrane coating layer on a green substrate, the green substrate comprising a plurality of cells comprised of a plurality of interior channels and a plurality of porous interior walls between the channels;
drying the at least one green membrane coating layer on the green substrate to produce a green coated substrate; and
firing the green coated substrate into a porous substrate,
wherein applying the at least one green membrane coating layer and the drying the at least one green membrane coating layer are repeated from 2 to 10 times prior to firing to form multiple green membrane coating layers on the green substrate and
wherein the firing the green coated substrate forms a ceramic honeycomb article comprised of the porous substrate and multiple fired coating layers on the porous substrate.

2. The method of claim 1, wherein the green substrate comprises cordierite precursors, and the firing of the green coated substrate is accomplished at from 1400 to 1450° C.

3. The method of claim 1 wherein the green substrate and the at least one layer of the multiple green membrane membrane layers comprises Si₃N₄—SiC precursors, and the firing of the green coated substrate is accomplished at from 1400 to 1700° C.

4. The method of claim 3, wherein the firing of the green coated substrate comprises at least one of:
heating the green coated substrate in an argon atmosphere to a melting point of silicon of about 1414 to 1450° C. and holding for 0.5 to 6 hours to melt the silicon and bond the silicon to particles of SiC;
changing the argon atmosphere to a nitrogen atmosphere to allow nitridation to occur and continue holding for 4 to 6 hours; and
further heating to 1500 to 1700° C. for from 0.5 to 10 hours.

5. The method of claim 4, wherein nitridation converts the silicon to Si₃N₄.

6. The method of claim 1, wherein the at least one green membrane coating layer comprises a Si₃N₄—SiC precursor slurry formulation having a solid loading of from 5 to 45 wt % comprised of: SiC particles, a binder, and a liquid carrier.

7. The method of claim 1, wherein the at least one green membrane coating layer comprises a cordierite precursor formulation having a solids content of from 5 to 45 wt % comprised of: a source of Al, a source of Si, a source of Mg, and a binder.

8. The method of claim 7, wherein the precursor formulation further comprises a pore former in an amount of from 0.1 to 60 wt % based on the weight of the solids content of the precursor formulation.

9. The method of claim 7, wherein the precursor formulation further comprises a pore former in an amount of from 2 to 60 wt % based on the weight of the solids content of the precursor formulation.

10. The method of claim 9, wherein the pore former comprises graphite.

11. The method of claim 1, wherein the green substrate is prepared by extrusion, wrapping, 3D printing, or combinations thereof.

12. The method of claim 1, further comprising finishing at least one aspect or facet of the green coated substrate or the ceramic honeycomb article, selected from at least one of:
end face machining, skinning, masking, polymer coating, sealing, ceramic glazing, membrane coating, fire polished, or a combination thereof.

13. The method of claim 1, wherein each of the fired coating layers has a D50 pore size, and each successive fired coating layer D50 pore size is less than the D50 pore size of a preceding fired coating layer.

14. The method of claim 1, wherein the green substrate is a honeycomb monolith having one end and another end opposite the one end, wherein alternate channel openings on one end are plugged and alternate channels on the other end are plugged, providing a filter article with inlet channels and outlet channels.

15. The method of claim 1, wherein the multiple fired coating layers results in an asymmetric membrane structure.

16. The method of claim 1, wherein the green membrane coating layer and the green substrate have the same reaction temperature.

17. The method of claim 1, wherein the green substrate and the at least one green membrane coating layer comprise cordierite precursors, and the firing of the green coated substrate is accomplished at from 1400 to 1450° C.

18. The method of claim 1, wherein the green substrate and the at least one green membrane coating layer comprise alumina.

19. The method of claim 1, wherein the at least one green membrane coating layer comprises alumina.

20. The method of claim 1 wherein the membrane coating layer is present in inlet channels.

21. The method of claim 1 wherein the membrane coating layer is absent in outlet channels.
